(19) United States
(12) Patent Application Publication
(10) Pub. No.: US 2007/0002828 A1
(43) Pub. Date: Jan. 4, 2007

(54) Methods, systems, and computer program products for taking a high-speed signaling link out of service from a proving state of an initial alignment procedure

(75) Inventors: Mahesh Tomar, Morrisville, NC (US); Komal G. Khungar, Morrisville, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/478,344

(22) Filed: Jun. 29, 2006

Related U.S. Application Data
(60) Provisional application No. 60/695,609, filed on Jun. 30, 2005.

(51) Int. Cl. H04L 12/28

(52) U.S. Cl. 370/351

(57) ABSTRACT

Methods, systems, and computer program products are provided for taking a high-speed signaling link out of service from a proving state of an initial alignment procedure in response to a flag delimitation error. According to one aspect, the method includes initializing an initial alignment procedure for validating the ability of a high-speed signaling link to carry signal units and transitioning to a proving state. While in the proving state, the method includes detecting a flag delimitation error and in response to detecting the flag delimitation error, starting a timer. The method further includes taking the link out of service based on the timer.

### CROSS-REFERENCE TO RELATED APPLICATION

This application claims the benefit of U.S. Provisional Patent Application Ser. No. 60/695,609 filed Jun. 30, 2005, the disclosure of which is incorporated by reference herein in its entirety.

### TECHNICAL FIELD

The subject matter described herein relates to monitoring of signal links for ability to transfer messages within a network. More particularly, the subject matter described herein relates to methods, systems, and computer program products for taking a high-speed signaling link out of service from a proving state of an initial alignment procedure in response to a flag delimitation error.

### BACKGROUND ART

Signaling links function to provide reliable transfer of signaling messages between two directly connected signaling points on a network. Signaling messages are transferred over the signaling link in variable length signal units. The signal units include transfer control information for proper operation of the signaling link in addition to the signaling information. Signaling link functions comprise: signal unit delimitation, signal unit alignment, error detection, error correction, initial alignment, signaling link error monitoring, and flow control. All of these functions are coordinated by the link state control.

Signaling System #7 (SS7) Level 2 employs two signaling link error rate monitor functions: one which is employed while a signaling link is in service and provides one of the criteria for taking the link out of service and another that is employed while a link is in the proving state of initial alignment procedure. These functions are called the signal unit error rate monitor (EIM on high-speed links) and the alignment error rate monitor (AERM), respectively.

The alignment error rate monitor is a linear counter, which is operated during normal and emergency proving periods. The counter is started from zero whenever the proving state of the alignment procedure is entered and is then incremented for every signal unit error detected. When the counter reaches a threshold value Tᵢ, that particular proving period is aborted. On receipt of a correct signal unit of expiry of that aborted proving period, the proving state is reentered. If proving is aborted M times, the link is returned to the out of service state. A threshold is defined for each of the two types of proving periods (normal and emergency). These are Tᵢₙ and Tᵢₑ and apply to the normal proving period and the emergency proving period, respectively. Proving is successfully completed when a proving period expires without an excessive error rate being detected and without the receipt of status indication out of alignment (O) or out of service (OS).

A problem has been discovered when the signal unit or flag delimitation is lost during alignment proving periods for a high-speed SS7 link. On low-speed links (56/64 kbps) the problem is not prevalent since SS7 specifications mandate that the link will go into octet counting mode until the next valid flag is encountered. Octet counting can be used to count octets after a flag delimitation error and to take the link out of service from the proving state after a defined number of octets are counted without receiving a valid flag. Octet counting is suitable for low speed links because the link data rates (e.g., 56 kbps or 64 kbps) do not impose a significant burden on the SS7 Level 2 hardware that performs the octet counting. However, SS7 high-speed links specifications invalidate the use of octet counting while link monitoring because the number of signaling units per unit time is significantly high and would therefore burden the hardware that performs octet counting. If octet counting is not used in the proving state, a link may be brought in service, even though it is not aligned. Such a link would eventually be taken out of service from the in service state. However, bringing an unaligned link in service and taking it immediately out of service is inefficient.

SS7 specifications that relate to link alignment (e.g., ITU-T Recommendation Q.703 and GR-246-CORE from Telcordia/Bellcore) mandate signaling unit error rate monitoring (EIM) while the link is in service. However, the specifications are not clear as to the monitoring function while the link is in the proving state of initial alignment. Accordingly, there exists a need for improved methods, systems, and computer program products for taking a link out of service from the proving state of the initial alignment procedure in response to a flag delimitation error.

### SUMMARY

According to one aspect, the subject matter described herein comprises a method for taking a high-speed signaling link out of service from a proving state of an initial alignment procedure in response to a flag delimitation error. The method includes initializing an initial alignment procedure for validating the ability of a high-speed signaling link to carry signal units and transitioning to a proving state. While in the proving state, the method includes detecting a flag delimitation error and in response to detecting the flag delimitation error, starting a timer. The method further includes taking the link out of service based on the timer.

According to another aspect, the subject matter described herein comprises a system for taking a high-speed signaling link of a telecommunications network out of service from a proving state of an initial alignment procedure in response to a flag delimitation error. The system includes an alignment function for initializing an initial alignment procedure for validating the ability of a high-speed signaling link to carry signal units and transitioning the link to a proving state. The system further includes a detector function for detecting a flag delimitation error and an interval timer function for performing a count and for taking the link out of service based on the count.

According to yet another aspect, the subject matter described herein for taking a high-speed signaling link out of service from a proving state of an initial alignment procedure can be implemented in hardware, software, firmware, or any combination thereof. In one implementation, the subject matter described herein can be implemented as a computer program product comprising computer executable instructions embodied in a computer readable medium. Exemplary computer readable media suitable for implementing the subject matter described herein includes disk memory devices, programmable logic devices, application specific integrated circuits, and downloadable electrical signals. In addition, a computer readable medium that implements the subject matter described herein may be distributed across multiple physical devices and/or computing platforms.

Accordingly, it is an object of the subject matter described herein to provide methods, systems, and computer program products for taking a high-speed signaling link out of service from a proving state of an initial alignment procedure in response to a flag delimitation error.

An object of the present subject matter having been stated hereinabove, and which is addressed in whole or in part by the present subject matter, other objects will become evident as the description proceeds when taken in connection with the accompanying drawings as best described hereinbelow.

### BRIEF DESCRIPTION OF THE DRAWINGS

Preferred embodiments of the subject matter described herein will now be explained with reference to the accompanying drawings of which:

FIG. 1 is a block diagram of a signaling network illustrating signaling links and signaling nodes which can encompass the methods and systems according to the subject matter described herein;

FIG. 2 is a block diagram of a signal transfer point encompassing the methods and systems according to the subject matter described herein;

FIG. 3 is a flow chart illustrating exemplary steps for taking a high-speed link out of service from a proving state according to the subject matter described herein; and

FIG. 4 is a flow chart illustrating exemplary steps for taking a high-speed link out of service from a proving state based on a timer according to the subject matter described herein.

### DETAILED DESCRIPTION

As described above, in common channel signaling networks, such as SS7 networks, adjacent nodes or signaling points in a network are connected by signaling links. The nodes or signaling points provide access to the SS7 network, provide access to databases, and transfer messages to other signaling points. Signaling links are transmission lines that carry signaling messages between the adjacent nodes. For reliability and load sharing purposes, multiple signaling links may connect two adjacent nodes in groups referred to as signaling linksets.

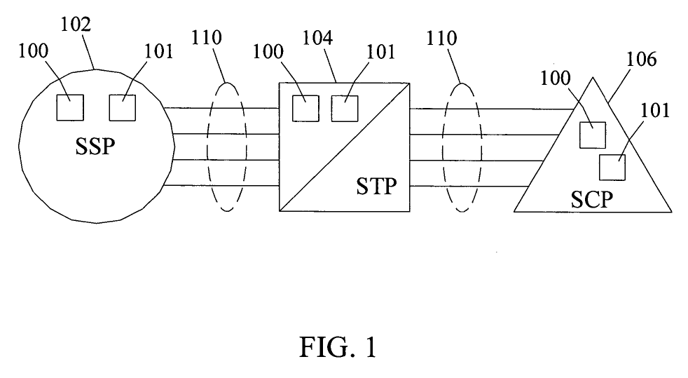

FIG. 1 illustrates an exemplary system for a signaling network including use of an alignment error rate monitor interval timer function (AERM IT) 100 and an alignment function 101 for taking a high-speed signaling link out of service from a proving state of an initial alignment procedure in response to a flag delimitation error. Referring to FIG. 1, a service switching point (SSP) 102 is connected to a signaling transfer point (STP) 104 and a service control point (SCP) 106 via signaling links 110. In an SS7 network, service switching points (SSP) 102, also known as end office switches or central office switches, perform call signaling functions and provide voice trunks for carrying media stream communications between end users. Signal transfer points (STP) 104 are packet switches that provide common channel signaling message routing and transport and route signaling messages between SS7 signaling points. Signal transfer points (STP) 104 are stored programmed control switches that use information contained in messages in conjunction with information stored in memory to route messages to the appropriate destination signaling point. Service control points (SCP) 106 are centralized databases that provide real-time access to call completion and information services. It is envisioned that the system of the subject matter described herein, including alignment error rate monitor interval timer function (AERM IT) 100 and alignment function 101 can be used with service switching points (SSP) 102, signal transfer points (STP) 104, or service control points (SCP) 106 when addressing high-speed signaling links 110, such as those supporting a data rate of at least 1.5 Mbit/s.

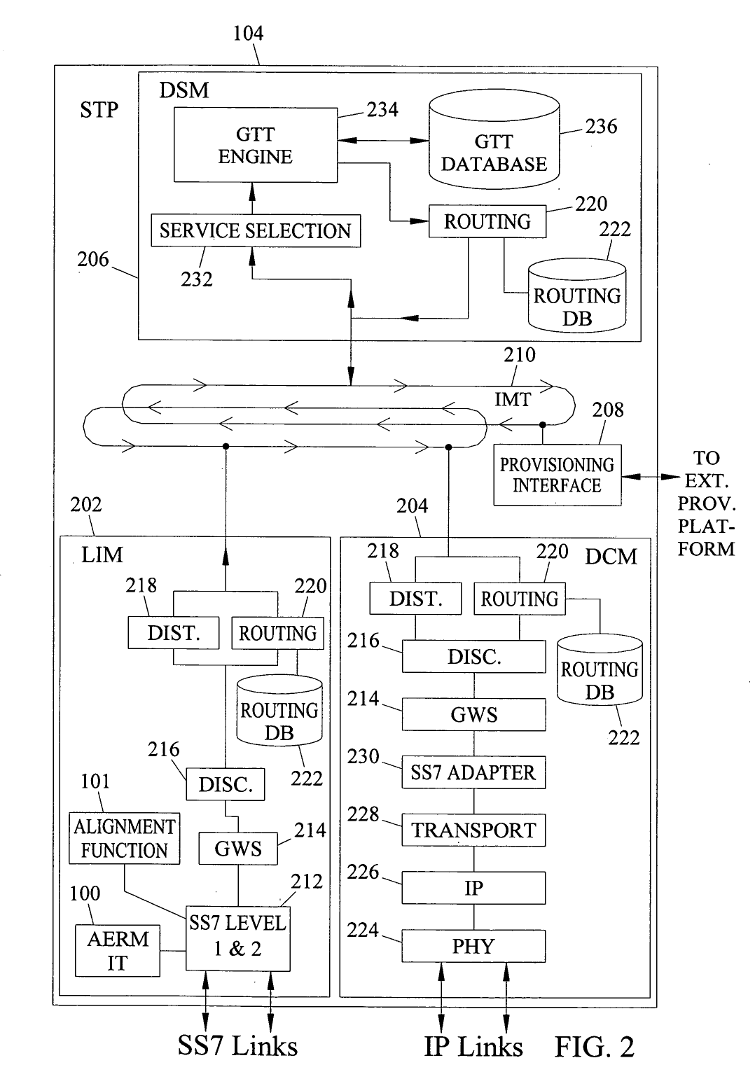

While it is envisioned that the methods, systems, and computer program products of the present subject matter can be used with any signaling point on the network, FIG. 2 illustrates a signal transfer point (STP) 104 embodying a system of the subject matter described herein. Referring to FIG. 2, STP 104 includes a plurality of internal processing modules for routing and processing SS7 messages. In the illustrated example, STP 104 includes a link interface module (LIM) 202 for sending and receiving SS7 messages via SS7 signaling links, a data communications module (DCM) 204 for sending and receiving SS7 messages via IP signaling links, a database services module (DSM) 206 for performing database related services, and a provisioning interface 208 for allowing an external system to provision databases within STP 104. In the illustrated example, modules 202, 204, 206 and 208 are connected via a counter-rotating, dual-ring bus 210.

SS7 link interface module (LIM) 202 can include an SS7 level one and two module 212 for performing SS7 level one and two functions, such as error detection, error correction, and sequencing of SS7 messages. It is envisioned that the system of the present subject matter, including alignment error rate monitor interval timer function 100 and alignment function 101, would be processed within this module. Gateway screening module 214 determines whether to allow messages into a network. Discrimination module 216 analyzes destination point codes in a message to determine whether further processing is required for the messages or whether the messages are to be through-switched. Distribution module 218 distributes messages identified by discrimination module 216 as requiring further processing to other internal processing modules for the processing to be performed. Routing module 220 routes messages identified by discrimination module 216 as being destined for other signaling nodes. Routing module 220 may access a routing database 222 to route the messages.

Data communications module (DCM) 204 can include a physical layer 224 for performing physical layer functions for IP signaling links. Internet protocol layer 226 performs IP layer functions, such as IP forwarding. Transport layer 228 performs transport layer functions, such as TCP or SCTP functions. SS7 adapter layer 230 performs functions for adapting SS7 traffic to be sent and/or received over an IP network. Gateway screening module 214, discrimination module 216, distribution module 218, routing module 220, and routing database 222 perform the same functions as those described above with regard to link interface module (LIM) 202. Hence a description of these functions will not be repeated herein.

Database services module (DSM) 206 can include a service selection module 232 for selecting a service for messages identified as requiring further internal processing and can include a global title translation engine 234 for selecting a global title translation mode from a plurality of different GTT modes based on a message and perform global title translation according to the selected global title translation mode. As is known to the art, global title translation involves resolving a called party address to the point code and subsystem number of an intermediate or final destination. The different GTT modes require searching a global title translation database 236 based on different matching criteria or qualifiers for translation matching of a signaling message to an entry in database 236. When a match entry is found in database 236 the message is modified to include data from the matching entry. Next, routing function 220 and routing database 222 can receive and route the message to a destination based on the inserted destination point code. Routing function 220 and routing database 222 can perform similar functions to those described with regard to link interface module (LIM) 102. Hence, a description thereof will not be repeated herein.

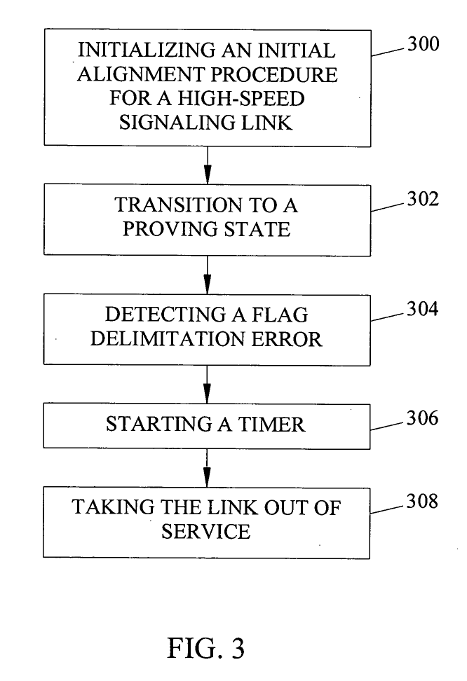

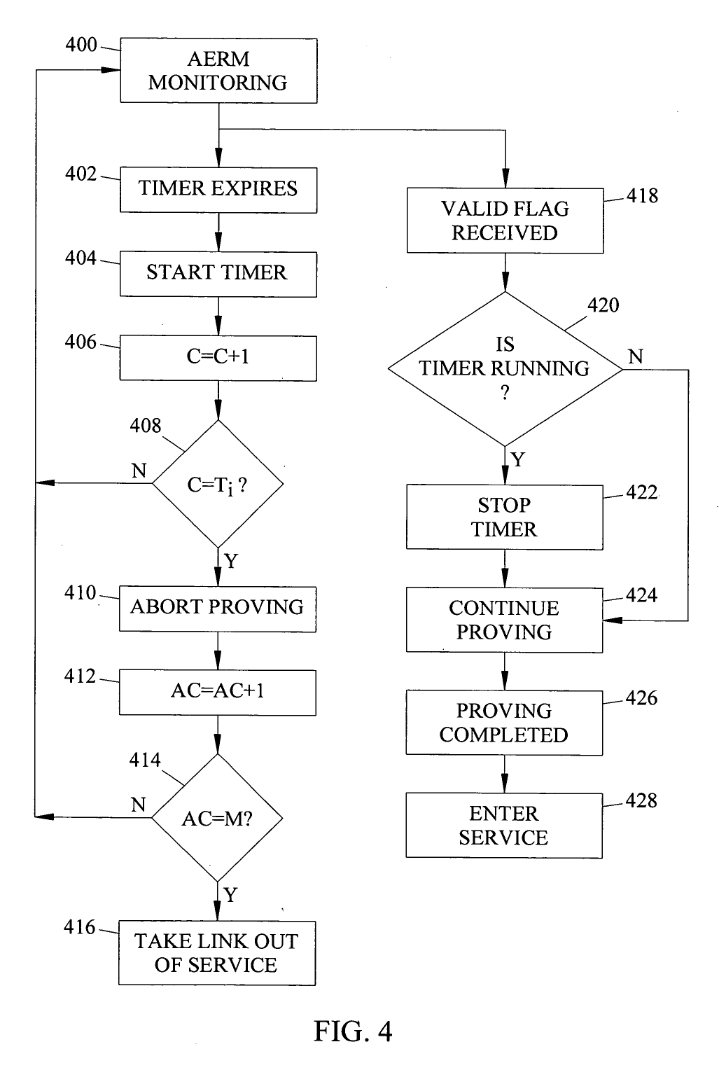

FIGS. 3 and 4 are flow charts illustrating exemplary control steps that may be performed in accordance with the present subject matter for taking a high-speed signaling link out of service from a proving state of an initial alignment procedure in response to a flag delimitation error. It will be appreciated that the method disclosed herein is accomplished without using octet counting, the standard used with low-speed links where the burden to hardware that performs octet counting is negligible.

Referring to step 300 in FIG. 3, an initial alignment procedure for a high-speed signaling link is initialized, such as through alignment function 101. The initial alignment procedure is used to reestablish the timing and alignment of signal units and can occur for both first time signaling link initialization and for restoration after a link failure. Two alignment procedures are generally used and are contemplated with the subject matter disclosed herein. Normal initial alignment can occur when other links are associated with the affected link, such as is the case with a linkset joining the same destination, and emergency initial alignment can occur when no other links are connected to an adjoining signaling point and involves a shorter time period than the normal alignment.

There are typically four states associated with the alignment procedure including: (1) an idle state when the procedure is suspended; (2) a not aligned state when the signaling link is not aligned and the local terminal broadcasts a status indicator (O) for out of alignment; (3) an aligned state when the signaling link is aligned and the local terminal broadcasts a status indicator (N) for normal alignment status or (E) for emergency alignment status, but the status indicator (N) for normal, (E) for emergency, or (OS) for out of service is not received on the link from the remote terminal; and (4) a proving state when the local signaling link terminal broadcasts a status indicator (N) or (E) but status indicator (O) or (OS) is not received.

The proving state as represented in step 302 in FIG. 3 involves the testing of the integrity of the link at the signaling point and must last a set amount of time before the link can enter the aligned link state. Proving can include a normal proving state for normal initial alignment or an emergency proving state for emergency initial alignment. As will be described in more detail below, once the proving state has been commenced, if a flag delimitation error is detected as in step 304, control proceeds to step 306 where a timer sequence is commenced. Based upon the functioning of the timer of step 306, control proceeds to step 308 where the link may be taken out of service.

With reference to FIG. 4 and as described briefly above, alignment error rate monitoring as in step 400 is performed during each normal and emergency proving period. In accordance with the method of the present subject matter, during this monitoring, if a flag delimitation error is detected (i.e., loss of a valid flag), a timer, such as AERM interval timer function 100, is started while the alignment error rate monitoring continues in “flag hunting” mode. If a valid flag is received as in step 418 during flag hunting at any point in the process, control proceeds to step 420 where a determination of whether the timer is running is made. If the timer is running, control proceeds to step 422 where the timer is stopped and the proving period continues as in step 424.

Assuming a valid flag is not received, if timer 100 expires as in step 402, control proceeds to step 404 where a new timer is started. Upon the expiration and restart of the timer as in steps 402, 404, a count C associated with the particular proving state entered is incremented by 1 as in step 406. In step 408, a determination of whether count C has reached a predetermined threshold value Tᵢ is made. Representative threshold values Tᵢ can include, for example, a value of 4 for a normal proving state or a value of 1 for an emergency proving state (which involves a shorter time period than the normal proving state). If count C has not reached threshold value Tᵢ, step 400 of AERM monitoring is reentered and the timer expiration, timer restart, and count incrementing is repeated. If count C has reached threshold value Tᵢ, control proceeds to step 410 where the particular proving period currently being undertaken is aborted.

If the proving period is aborted as in step 410, an abort count AC is incremented by 1 as in step 412. In step 414, a determination of whether abort count AC has reached a predetermined abort count threshold value M is made. A representative abort count threshold value M can include, for example, a value of 5. If abort count AC has not reached abort count threshold value M, a new proving period is begun and step 400 of AERM monitoring is reentered. If abort count AC has reached threshold value M, the link is taken out of service as in step 416 and the link is returned to an out of service (OS) state. Only following a completion of the proving procedure as in step 426, is a signaling link entered into an aligned ready state and subsequent in-service state as in step 428.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for taking a high-speed signaling link out of service from a proving state of an initial alignment procedure in response to a flag delimitation error, the method comprising:
(a) initializing an initial alignment procedure for validating the ability of a high-speed signaling link to carry signal units and transitioning to a proving state; and
(b) in the proving state:
(i) detecting a flag delimitation error;
(ii) in response to detecting the flag delimitation error, starting a timer; and
(iii) taking the link out of service based on the timer.

2. The method of claim 1 wherein the high-speed signaling link supports a data rate of at least about 1.5 Mbit/s.

3. The method of claim 1 wherein starting the timer comprises starting an alignment error rate monitor interval timer.

4. The method of claim 3 wherein the alignment error rate monitor interval timer is located within a signal transfer point.

5. The method of claim 3 wherein the alignment error rate monitor interval timer is located within a service switching point.

6. The method of claim 3 wherein the alignment error rate monitor interval timer is located within a service control point.

7. The method of claim 1 wherein taking the link out of service based on the timer comprises:
(a) incrementing a count C associated with the proving state;
(b) determining whether the count C has reached a threshold value Tᵢ;
(c) in response to determining that the count C has reached the threshold value Tᵢ, incrementing an abort count;
(d) determining whether the abort count has reached a threshold value M; and
(e) in response to determining that the abort count has reached the threshold value M, taking the signaling link out of service.

8. The method of claim 7 wherein transitioning to the proving state includes transitioning to a normal proving state for normal initial alignment.

9. The method of claim 8 wherein the threshold value Tᵢ is equal to 4 and the threshold value M is equal to 5.

10. The method of claim 9 wherein the time to take the signaling link out of service after detection of the flag delimitation error is approximately 200 msec.

11. The method of claim 7 wherein transitioning to the proving state includes transitioning to an emergency proving state for emergency initial alignment.

12. The method of claim 1 1 wherein the threshold value Tᵢ is equal to 1 and the threshold value M is equal to 5.

13. The method of claim 12 wherein the time to take the signaling link out of service after detection of the flag delimitation error is approximately 50 msec.

14. The method of claim 1 wherein taking the link out of service based on the timer comprises taking the link out of service without using octet counting.

15. The method of claim 1 comprising stopping the timer in response to receipt of a valid flag.

16. A system for taking a high-speed signaling link of a telecommunications network out of service from a proving state of an initial alignment procedure in response to a flag delimitation error, the system comprising:
(a) an alignment function for initializing an initial alignment procedure for validating the ability of a high-speed signaling link to carry signal units and transitioning the link to a proving state;
(b) a detector function for detecting a flag delimitation error; and
(c) an interval timer function for performing a count and for taking the link out of service based on the count.

17. The system of claim 16 wherein the high-speed signaling link supports a data rate of at least about 1.5 Mbit/s.

18. The system of claim 16 wherein the interval timer function comprises an alignment error rate monitor interval timer.

19. The system of claim 18 wherein the alignment error rate monitor interval timer is located within a signal transfer point.

20. The system of claim 18 wherein the alignment error rate monitor interval timer is located within a service switching point.

21. The system of claim 18 wherein the alignment error rate monitor interval timer is located within a service control point.

22. The system of claim 16 wherein the interval timer function comprises:
(a) a counter for incrementing a count C associated with the proving state and determining whether the count C has reached a threshold value Tᵢ; and
(b) an abort counter for incrementing an abort count in response to determining that the count C has reached the threshold value Tᵢ, and for determining whether the abort count has reached a threshold value M, wherein the signaling link is taken out of service if the abort count has reached the threshold value M.

23. The system of claim 22 wherein the alignment function is adapted to transition the link to a normal proving state for normal initial alignment.

24. The system of claim 23 wherein the threshold value Tᵢ is equal to 4 and the threshold value M is equal to 5.

25. The system of claim 24 wherein the time to take the signaling link out of service after detection of the flag delimitation error is approximately 200 msec.

26. The system of claim 22 wherein the alignment function is adapted to transition the link to an emergency proving state for emergency initial alignment.

27. The system of claim 26 wherein the threshold value Tᵢ is equal to 1 and the threshold value M is equal to 5.

28. The system of claim 27 wherein the time to take the signaling link out of service after detection of the flag delimitation error is approximately 50 msec.

29. The system of claim 16 wherein the interval timer function is adapted to take the link out of service without using octet counting.

30. The system of claim 16 wherein the interval timer function is adapted to be stopped in response to receipt of a valid flag.

31. A computer program product comprising computer executable instructions embodied in a computer readable medium for performing steps comprising:
(a) initializing an initial alignment procedure for validating the ability of a high-speed signaling link to carry signal units and transitioning to a proving state; and
(b) in the proving state:
(i) detecting a flag delimitation error;
(ii) in response to detecting the flag delimitation error, starting a timer; and
(iii) taking the link out of service based on the timer.

32. The computer program product of claim 31 wherein the high-speed signaling link supports a data rate of at least about 1.5 Mbit/s.

33. The computer program product of claim 31 wherein starting the timer comprises starting an alignment error rate monitor interval timer.

34. The computer program product of claim 33 wherein the alignment error rate monitor interval timer is located within a signal transfer point.

35. The computer program product of claim 33 wherein the alignment error rate monitor interval timer is located within a service switching point.

36. The computer program product of claim 33 wherein the alignment error rate monitor interval timer is located within a service control point.

37. The computer program product of claim 31 wherein taking the link out of service based on the timer comprises:
(a) incrementing a count C associated with the proving state;
(b) determining Whether the count C has reached a threshold value Tᵢ;
(c) in response to determining that the count C has reached the threshold value Tᵢ, incrementing an abort count;
(d) determining whether the abort count has reached a threshold value M; and
(e) in response to determining that the abort count has reached the threshold value M, taking the signaling link out of service.

38. The computer program product of claim 37 wherein transitioning to the proving state includes transitioning to a normal proving state for normal initial alignment.

39. The computer program product of claim 38 wherein the threshold value Tᵢ is equal to 4 and the threshold value M is equal to 5.

40. The computer program product of claim 39 wherein the time to take the signaling link out of service after detection of the flag delimitation error is approximately 200 msec.

41. The computer program product of claim 37 wherein transitioning to the proving state includes transitioning to an emergency proving state for emergency initial alignment.

42. The computer program product of claim 41 wherein the threshold value Tᵢ is equal to 1 and the threshold value M is equal to 5.

43. The computer program product of claim 42 wherein the time to take the signaling link out of service after detection of the flag delimitation error is approximately 50 msec.

44. The computer program product of claim 31 wherein taking the link out of service based on the timer comprises taking the link out of service without using octet counting.

45. The computer program product of claim 31 comprising stopping the timer in response to receipt of a valid flag.
